(19) United States
(12) Patent Application Publication
(10) Pub. No.: US 2016/0231169 A1
(43) Pub. Date: Aug. 11, 2016

(54) INFRARED DETECTING SWITCH FOR SURVEILLANCE CAMERA

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: TONG-QI HUANG, Wuhan (CN); CHUN-SHENG CHEN, New Taipei (TW)

(21) Appl. No.: 14/683,944

(22) Filed: Apr. 10, 2015

(30) Foreign Application Priority Data
Feb. 9, 2015 (CN) 201510065871.6

(51) Int. Cl. G01J 1/46; H04N 7/18; G01V 8/10

(52) U.S. Cl. CPC G01J 1/46; G01V 8/10; H04N 7/183; H04N 7/188

(57) ABSTRACT

An infrared detecting switch for a surveillance camera includes a detector, an amplifier circuit, and a switch circuit. The detector can detect infrared radiation emitted by a person and output a voltage signal. The amplifier circuit can receive the voltage signal and amplify the voltage signal. The switch circuit can receive the voltage signal and supply power to the surveillance camera.

### CROSS-REFERENCE TO RELATED APPLICATIONS

This application claims priority to Chinese Patent Application No. 201510065871.6 filed on Feb. 9, 2015, the contents of which are incorporated by reference herein.

### FIELD

The subject matter herein generally relates to infrared detecting switch for surveillance cameras.

### BACKGROUND

Surveillance cameras may include video cameras which can be used for observing an area. The surveillance cameras are often connected to recording devices through network, and may be viewed for security reasons.

### BRIEF DESCRIPTION OF THE DRAWINGS

Implementations of the present technology will now be described, by way of example only, with reference to the attached figures.

FIG. 1 is a block diagram of an embodiment of an infrared detecting switch for a surveillance camera.

FIG. 2 is a circuit diagram of the infrared detecting switch for the surveillance camera of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

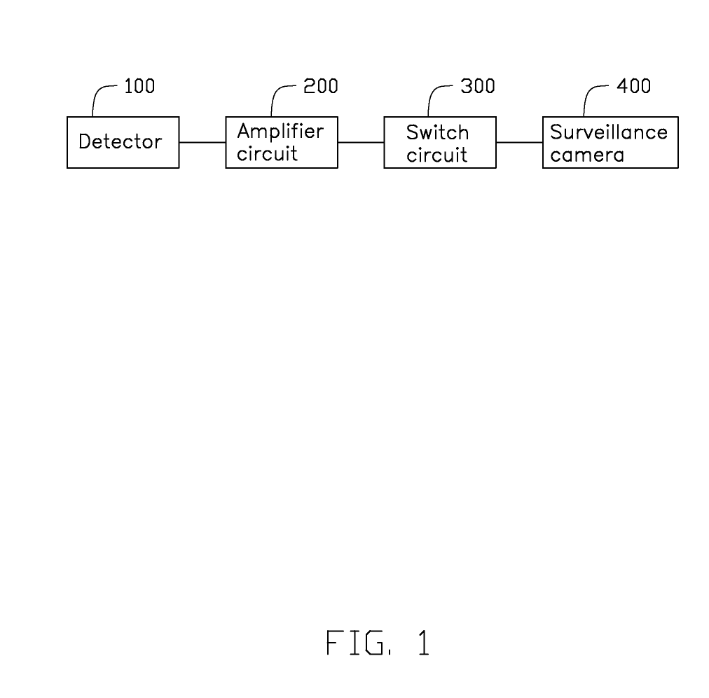

FIG. 1 illustrates an infrared detecting switch for a surveillance camera in accordance with an embodiment. The infrared detecting switch includes a detector 100, an amplifier circuit 200, a switch circuit 300, and a surveillance camera 400.

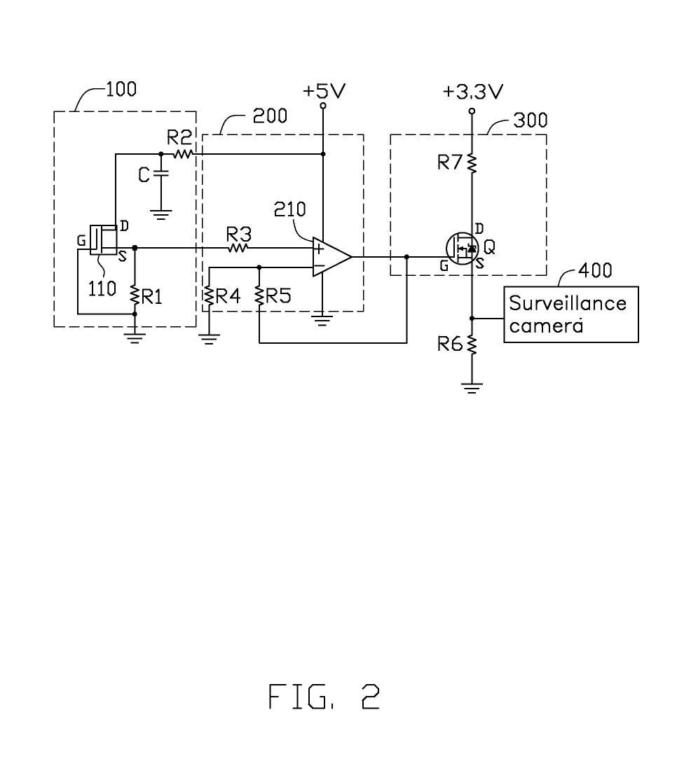

FIG. 2 illustrates that the detector 100 includes a detector 110, a first resistor R1, a second resistor R2, and a capacitor C. The detector 110 includes a gate, a source, and a drain. The gate of the detector 110 is grounded. The source of the detector 110 is grounded via the first resistor R1. The drain of the detector 110 receives a first DC voltage via the second resistor R2. The drain of the detector 110 is grounded via the capacitor C. In one embodiment, the detector 110 is an infrared heat detector. The first DC voltage is about +5 volts.

The amplifier circuit 200 includes an amplifier 210, a third resistor R3, a fourth resistor R4, and a fifth resistor R5. The amplifier 210 includes an inverting input terminal, a non-inverting input terminal, an output terminal, and a power terminal. The non-inverting input terminal of the amplifier 210 is electrically coupled to the source of the detector 110 via the third resistor R3. The inverting input terminal of the amplifier 210 is grounded via the fourth resistor R4. The inverting input terminal of the amplifier 210 is electrically coupled to the output terminal of the amplifier 210 via the fifth resistor R5. The power terminal of the amplifier 210 receives the first DC voltage.

The switch circuit 300 includes a MOSFET Q, a sixth resistor R6, and a seventh resistor R7. The MOSFET Q includes a gate, a source, and a drain. The gate of the MOSFET Q is electrically coupled to the output terminal of the amplifier 210. The source of the MOSFET Q is grounded via the sixth resistor R6 and is electrically coupled to the surveillance camera 400. The drain of the MOSFET Q receives a supplying DC voltage via the seventh resistor R7. In one embodiment, the MOSFET Q is an n-channel MOSFET. The supplied DC voltage is about +3.3 volts. A resistance of the sixth resistor R6 is about 1000 ohm. A resistance of the seven resistor R7 is about 1000 ohm

In use, when a person moves into a surveillance area of the surveillance camera 400, the detector 110 detects infrared radiation emitted by the person. The detector 110 outputs a voltage signal to the amplifier 210. The non-inverting input terminal of the amplifier 210 receives the voltage signal and amplifies the voltage signal. The MOSFET Q turns on when the gate of the MOSFET Q receives the amplified voltage signal. The surveillance camera 400 is coupled to the supplying DC voltage and being supplied. The surveillance camera 400 can work to take videos.

In one embodiment, the detector 110 can detect an infrared radiation which is can be recognized as a person to output the voltage signal.

The embodiments shown and described above are only examples. Many details are often found in the art such as the other features of an infrared detecting switch for surveillance camera. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An infrared detecting switch for a surveillance camera, comprising:
a detector configured to detect infrared radiation emitted by a person, and output a voltage signal;
an amplifier circuit configured to receive the voltage signal and amplify the voltage signal; and
a switch circuit configured to receive the amplified voltage signal and coupling the surveillance camera to a supplying DC voltage.

2. The infrared detecting switch of claim 1, wherein the detector comprises a detector, a first resistor, a second resistor, and a capacitor; the detector comprises a gate, a source, and a drain; the gate of the detector is grounded; the source of the detector is grounded via the first resistor; the drain of the detector receives a first DC voltage via the second resistor; and the drain of the detector is grounded via the capacitor.

3. The infrared detecting switch of claim 2, wherein the detector is an infrared heat detector; and the first DC voltage is +5 volts.

4. The infrared detecting switch of claim 2, wherein the amplifier circuit comprises an amplifier, a third resistor, a fourth resistor, and a fifth resistor; the amplifier comprises an inverting input terminal, a non-inverting input terminal, an output terminal, and a power terminal; the non-inverting input terminal of the amplifier is electrically coupled to the source of the detector via the third resistor; the inverting input terminal of the amplifier is grounded via the fourth resistor; the inverting input terminal of the amplifier is electrically coupled to the output terminal of the amplifier via the fifth resistor; and the power terminal of the amplifier receives the first DC voltage.

5. The infrared detecting switch of claim 4, wherein the switch circuit comprises a MOSFET, a sixth resistor, and a seventh resistor; the MOSFET Q comprises a gate, a source, and a drain; the gate of the MOSFET is electrically coupled to the output terminal of the amplifier; the source of the MOSFET is grounded via the sixth resistor, and is coupled to the surveillance camera; the drain of the MOSFET camera receives the supplying DC voltage via the seventh resistor.

6. The infrared detecting switch of claim 5, wherein the MOSFET is an n-channel MOSFET; and the supplying DC voltage is +3.3 volts.

7. The infrared detecting switch of claim 5, wherein the MOSFET turns on when the gate of the MOSFET receives the voltage signal; the drain of the MOSFET supply power to the surveillance camera.

8. The infrared detecting switch of claim 5, wherein a resistance of the sixth resistor is about 1000 ohm.

9. The infrared detecting switch of claim 5, wherein a resistance of the seven resistor is about 1000 ohm.

10. An infrared detecting switch for a surveillance camera, comprising:
a detector configured to detect infrared radiation emitted by a person and output a voltage signal;
an amplifier circuit configured to receive the amplified voltage signal and amplify the voltage signal;
a switch circuit comprising a MOSFET;
wherein the MOSFET comprises a gate, a source, and a drain; the MOSFET turns on when the gate of the MOSFET receives the amplified voltage signal; the drain of the MOSFET is coupled to a supplying DC voltage; the source of the MOSFET is coupled to the surveillance camera.

11. The infrared detecting switch of claim 10, wherein the detector comprises a detector, a first resistor, a second resistor, and a capacitor; the detector comprises a gate, a source, and a drain; the gate of the detector is grounded; the source of the detector is grounded via the first resistor; the drain of the detector receives a first DC voltage via the second resistor; and the drain of the detector is grounded via the capacitor.

12. The infrared detecting switch of claim 11, wherein the detector is an infrared heat detector; and the first DC voltage is +5 volts.

13. The infrared detecting switch of claim 11, wherein the amplifier circuit comprises an amplifier, a third resistor, a fourth resistor, and a fifth resistor; the amplifier comprises an inverting input terminal, a non-inverting input terminal, an output terminal, and a power terminal; the non-inverting input terminal of the amplifier is electrically coupled to the source of the detector via the third resistor; the inverting input terminal of the amplifier is grounded via the fourth resistor; the inverting input terminal of the amplifier is electrically coupled to the output terminal of the amplifier via the fifth resistor; and the power terminal of the amplifier receives the first DC voltage.

14. The infrared detecting switch of claim 13, wherein the switch circuit further comprises a sixth resistor and a seventh resistor; the MOSFET comprises a gate, a source, and a drain; the gate of the MOSFET is electrically coupled to the output terminal of the amplifier; the source of the MOSFET is grounded via the sixth resistor, and is coupled to the surveillance camera; the drain of the MOSFET receives the supplying DC voltage via the seventh resistor camera.

15. The infrared detecting switch of claim 14, wherein the MOSFET is an n-channel MOSFET; and the supplying DC voltage is +3.3 volts.

16. The infrared detecting switch of claim 14, wherein a resistance of the sixth resistor is about 1000 ohm.

17. The infrared detecting switch of claim 14, wherein a resistance of the seven resistor is about 1000 ohm.

18. An infrared detection switch for a surveillance camera comprising:
an infrared heat detector for detecting heat radiating from a person within a detection area;
an amplifier circuit; and
a switch circuit;
wherein, when the infrared heat detector detects heat from a person within the detecting area, the detector outputs a detection voltage signal to the amplifier circuit;
wherein, when the amplifier circuit receives the detection voltage signal, the amplifier circuit amplifies the detection voltage signal to a switch activation signal and output the switch activation signal to the switch circuit; and
wherein, when the switch circuit receives the switch activation signal, the switch circuit couples the surveillance camera to a power supply activating the surveillance camera.
